(19) United States
(12) Patent Application Publication
(10) Pub. No.: US 2014/0355966 A1
(43) Pub. Date: Dec. 4, 2014

(54) Electrical Heating Device For A Motor Vehicle And Vehicle And Associated Air-Conditioning And/Or Heating Unit

(71) Applicant: Valeo Systemes Thermiques, Les Mesnil St. Denis (FR)

(72) Inventors: Frederic Pierron, Rambouillet (FR); Laurent Tellier, Paris (FR); Jose Leborgne, Luisant (FR)

(21) Appl. No.: 14/342,839

(22) PCT Filed: Sep. 4, 2012
(86) PCT No.: PCT/EP2012/003686

§ 371 Date: May 27, 2014

(30) Foreign Application Priority Data
Sep. 6, 2011 (FR) 11/02698

(51) Int. Cl. B60H 1/22; F24H 1/12

(52) U.S. Cl. CPC B60H 1/2221; B60H 1/22; F24H 1/121; B60H 2001/2287
USPC 392/360; 392/481

(57) ABSTRACT

The invention relates to an electrical liquid heating device for a motor vehicle, said heating device comprising at least one module for heating the aforementioned liquid. The device is characterised in that the at least one heating module comprises: a substantially cylindrical chamber (13,113,213) having at least one heating means (114) for heating the liquid and defining a circuit (15,115,215) for guiding the liquid to be heated; and a control means (9,109,209) for controlling said at least one heating means (114), positioned facing one end of the cylindrical chamber (13,113,213).

The invention relates to an electrical heating device for a motor vehicle. The invention applies more particularly to heating and/or air-conditioning units of motor vehicles.

Conventionally, the heating up of the air intended for heating the passenger compartment of a motor vehicle, and also for defogging and defrosting, is carried out by the passage of a flow of air through a heat exchanger, more precisely by an exchange of heat between the flow of air and a liquid.

In general, this is the coolant in the case of a heat engine.

However, this mode of heating may prove unsuitable or insufficient to ensure rapid and effective heating of the passenger compartment of the vehicle, in particular to heat up the passenger compartment or to ensure defogging or defrosting before the vehicle is used in a very cold environment or else when a very rapid increase in the temperature is desired.

In the case of an electric vehicle, the heating function is no longer realized by the circulation of the coolant in the heat exchanger.

A water circuit may be provided to heat the passenger compartment.

This mode of heating may prove unsuitable or insufficient to ensure rapid and effective heating of the passenger compartment of the vehicle.

Furthermore, in order to reduce the space requirement and the costs on account of the additional water circuit, it is also known to use, for the electric vehicle, an air-conditioning loop that operates in a heat pump mode. Thus, the air-conditioning loop for cooling a flow of air in a conventional manner with the aid of a coolant fluid is used in this case to heat up the flow of air. For this purpose, it is appropriate to use an evaporator of the air-conditioning loop as a condenser.

However, this mode of heating may also prove unsuitable or insufficient. This is because the performance of the air-conditioning loop in the heat pump mode is dependent on outside climatic conditions; in this case, outside air at an excessively low temperature cannot be used as a source of heat energy.

In order to alleviate these drawbacks of the prior art, a known solution consists in adding an additional electrical heating device to the heat exchanger or to the water circuit or else to the air-conditioning loop.

Such an electrical heating device may be suitable for upstream heating of the liquid, such as the coolant for the heat engine, or the water for the water circuit for heating the passenger compartment of the electric vehicle or else the coolant fluid of the air-conditioning loop.

However, the known electrical heating devices may have a large head loss.

Therefore, the object of the invention is to propose an electrical heating device that has a reduced space requirement and makes it possible to reduce the head loss.

To this end, the subject of the invention is an electrical liquid heating device for a motor vehicle, said heating device comprising at least one module for heating said liquid, characterized in that said at least one heating module comprises:
an approximately cylindrical enclosure having at least one means for heating said liquid and delimiting a circuit for guiding the liquid to be heated, and
a control means of said at least one heating means, positioned facing one end of said cylindrical enclosure.

The heating device may also have one or more of the following features, taken separately or in combination:
said device has at least one liquid inlet canal and at least one liquid outlet canal communicating with said circuit for guiding said liquid, said canals being provided in said device in a manner approximately perpendicular to the longitudinal axis of said cylindrical enclosure;
said cylindrical enclosure has at least one resistive track connected to said control means;
said at least one heating module comprises a core positioned in the interior of said cylindrical enclosure so as to define a circuit for guiding said liquid between said core and said cylindrical enclosure;
said core has an approximately cylindrical overall shape;
said core has at least one external groove facing said cylindrical enclosure, for example having an approximately helical or circular shape;
said core has an interior hollow communicating with said guiding circuit so as to act as a reserve for said heated liquid and as an expansion vessel;
said cylindrical enclosure has at least one opening in which said at least one heating means is positioned;
said inlet canal and outlet canal lead into a circuit for guiding said liquid, said circuit being defined around said cylindrical enclosure;
said at least one heating means has heating elements having a positive temperature coefficient;
said cylindrical enclosure has a support for said control means, produced in one piece with said cylindrical enclosure;
said device has a partition extending in the interior of said cylindrical enclosure;
said inlet canal and outlet canal lead into the interior of said cylindrical enclosure;
said partition is produced in one piece with a support for said control means;
said inlet canal and outlet canal extend approximately radially with respect to said cylindrical enclosure;
said inlet canal and outlet canal are positioned so as to form a projection with respect to said heating module;
said inlet canal and outlet canal are positioned in an opposing manner on two opposite sides of said heating module;
said device has a protective cover for said control means;
said device has sealing means between said protective cover and the support for said control means.

The invention also relates to a heating and/or air-conditioning unit for a motor vehicle, characterized in that it comprises an electrical heating device as defined above.

Further features and advantages of the invention will become more clearly apparent from reading the following description, given by way of nonlimiting and illustrative example, and from the appended drawings, in which:

FIG. 1 schematically shows in a simplified manner a heating unit of a motor vehicle, comprising an additional electrical heating device,

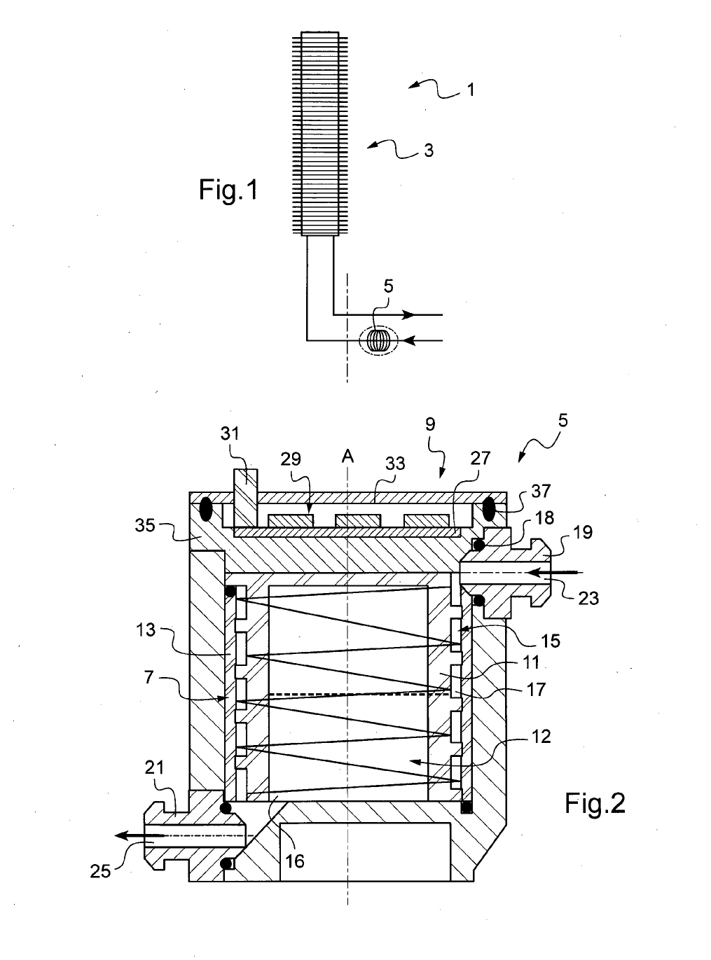

FIG. 2 is a sectional view of the heating device according to a first embodiment,

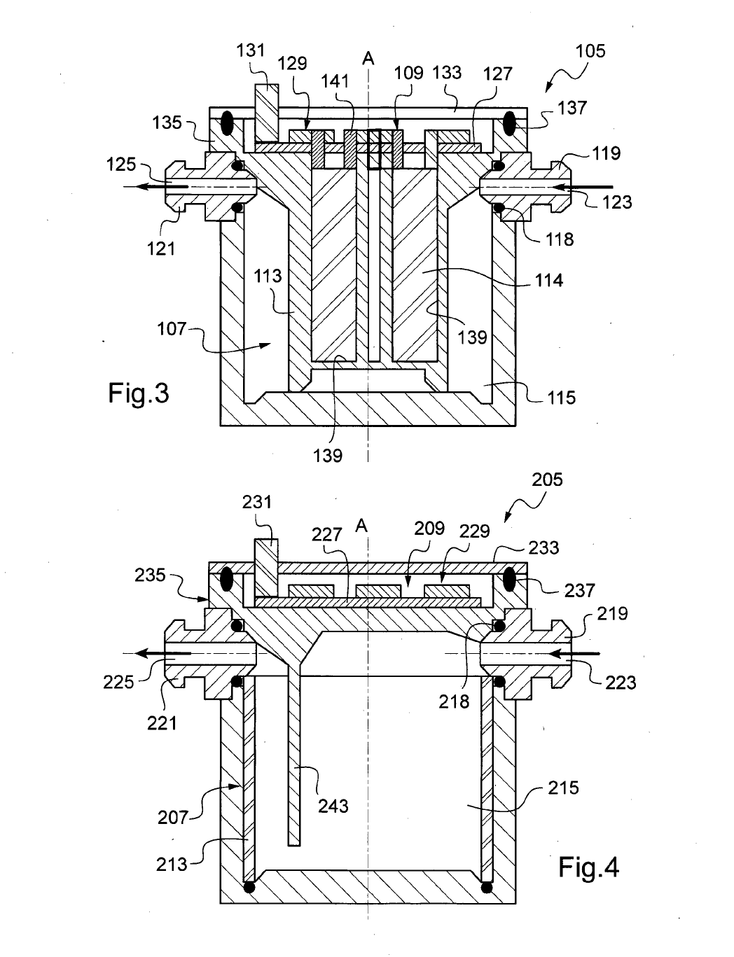

FIG. 3 is a sectional view of the heating device according to a second embodiment for the inlet and outlet of the fluid, and

FIG. 4 is a sectional view of the heating device according to a third embodiment.

In these figures, substantially identical elements have the same references.

The elements in FIGS. 3 and 4 that correspond to the elements in FIG. 2 have the same references increased respectively by 100 and 200.

FIG. 1 schematically shows a part of a motor vehicle heating and/or air-conditioning unit 1, comprising a water heating circuit 3 for heating the passenger compartment of an electric vehicle.

This heating unit comprises, upstream of the water heating circuit 3, an additional electrical heating device 5 for heating the water before it enters the heating circuit 3.

Shown here is the case of a water circuit for heating the passenger compartment of an electric vehicle.

Of course, it is also possible to provide for the electrical heating device 5 to be located upstream of the evaporator of an air-conditioning loop that is able to operate in a heat pump mode, so as to heat the coolant fluid.

It may also be possible to provide such an electrical heating device 5 upstream of a heat exchanger using the coolant of the heat engine as heat transfer liquid.

It may also be possible to provide such an electrical heating device 5 upstream of a heat exchanger intended to thermally regulate an electrical energy storage device, sometimes known as a battery pack, for an electric or hybrid vehicle.

With reference to FIG. 2, a first embodiment of this electrical heating device 5 will now be described in more detail.

The heating device 5 has:
a heating module 7, and
a control means 9 of the heating module 7.

The heating module 7 is accommodated in an associated housing of the heating device 5.

This heating module 7 has an approximately cylindrical overall shape.

The heating module 7 comprises a central core 11 and an enclosure 13 having an approximately cylindrical shape, said enclosure 13 having a heating means and surrounding the central core 11.

The central core 11 and the enclosure 13 define a circuit 15 for guiding the liquid to be heated between the central core 11 and the enclosure 13.

Thus, the external surface of the central core 11 and the internal surface of the enclosure 13 define a circulation volume of the liquid to be heated. Elements for disrupting the flow of liquid in the guiding circuit 15 may be provided so as to increase the heat exchange between the liquid and the enclosure 13.

The central core 11 may be produced in the form of a hollow body.

This hollow, also known as the internal cavity 12 of the core 11, advantageously acts as an expansion vessel. Such an internal cavity 12 makes it possible to absorb the variations in volume of the liquid that result from the heating of this liquid.

Specifically, the internal cavity 12 of the central core 11 forms a reserve or a means for storing the heated liquid or heat transfer fluid. To this end, the central core 11 has a communicating passage 16 between the circuit 15 for guiding the liquid and the cavity 12 in the interior of the central core 11.

In addition, this means for storing the heated liquid allows the hydraulic circuit having such a heating device 5 to absorb the expansion of the heated fluid, as is shown in FIG. 2.

More specifically, the internal cavity 12 contains air in its upper part and this air is able to be compressed under the effect of the expansion of the water. The upper part of the internal cavity 12, with reference to FIG. 2, is demarcated in a schematic and simplified manner by dotted lines.

The core 11 may also comprise an expansion control means.

This control means may be for example of the type of at least one calibrated passage, through which the heat transfer fluid is able to circulate. According to this variant, which is not illustrated, it is possible, for this purpose, to provide a fixed partition at the end of the core 11, which thus defines an internal volume of the expansion vessel and is provided with at least one calibrated passage, through which the heat transfer fluid is able to circulate.

According to another variant, which is not shown, the expansion control means may have a mobile partition that is able to slide along the internal cavity 12 of the core 11 with the expansion of the fluid.

Furthermore, it is possible for example to provide a reserve of heated liquid of around 0.4 to 0.5 L.

The central core 11 has for example an approximately cylindrical shape.

Provision may be made for the core 11 to have a section that is approximately constant or, by contrast, varying.

With an approximately constant section of the central core 11, the liquid flows at a constant speed through the guiding circuit 15.

By contrast, with a varying section, the speed of flow changes along the guiding circuit 15.

Moreover, according to the embodiment illustrated, the core 11 has an approximately helical external groove 17 on its external surface, that is to say facing the internal surface of the enclosure 13. On account of this helical groove 17, the guiding circuit 15 defines an approximately helical path.

Of course, provision may be made, as a variant, for the external surface of the core 11 to be without a groove, so as to define an axial guiding circuit parallel to the longitudinal axis A.

According to yet another variant, which is not shown, the core 11 may have a plurality of circular grooves on its external surface. In this case, a communicating orifice is provided in the region of each circular groove such that the interior of the core 11 communicates with the guiding circuit 15. Thus, the liquid passing into a heating module 7 flows inside the core 11 and around the core 11 in a circular manner.

For its part, of course, the enclosure 13 is produced in the form of a hollow body so that the central core 11 is received in the interior of the enclosure 13.

The central core 11 and the enclosure 13 may be concentric.

As mentioned above, the enclosure 13 comprises heating elements controlled by the control means 9 for heating the liquid by heat exchange between the enclosure 13 and the liquid circulating in the guiding circuit 15.

The enclosure 13 may for example have at least one resistive track connected to the control means 9 of the heating module 7.

The resistive track or tracks is/are produced for example by screen printing on the external surface of the enclosure 13, that is to say opposite the surface of the enclosure 13 facing the central core 11.

In addition, the enclosure 13 may have sealing means 18 positioned in the region of the ends of the enclosure 13.

For this exemplary embodiment, the heating means of the enclosure 13 is for example configured for power of around 2, 3, 4 or else 6 kW, depending on the application.

The heating device 5 also has at least one liquid inlet 19 and at least one liquid outlet 21 communicating with the guiding circuit 15 so as to allow the liquid to flow in the heating module 7.

This inlet 19 and outlet 21 are produced for example in the form of an inlet tube 19 and an outlet tube 21, respectively.

The inlet tube 19 and the outlet tube 21 are, for example, respectively positioned in a projecting manner with respect to the heating device 5. In the example illustrated, this inlet canal 23 and outlet canal 25 also form a projection with respect to the body of the heating device 5 accommodating the heating module 7.

The inlet tube 19 has an inlet canal 23 for the admission of the liquid. Similarly, the outlet tube 21 has an outlet canal 25 for the evacuation of the liquid.

The inlet canal 23 and outlet canal 25 may for example be respectively provided in the body of the device 5 perpendicularly to the longitudinal axis A of the cylindrical enclosure 13.

According to the example illustrated, the inlet canal 23 and outlet canal 25 are respectively provided in the body of the device 5 perpendicularly to the longitudinal axis A of the heating module 7.

The inlet canal 23 and outlet canal 25 extend for example approximately radially with respect to the cylindrical enclosure 13 and to the core 11, and thus, in this example, with respect to the heating module 7.

Moreover, the inlet canal 23 and outlet canal 25 may be positioned on two opposite sides of the heating module. The inlet canal 23 and outlet canal 25 may also be positioned in an opposing manner, that is to say at the two opposite ends of the device 5, as in the example in FIG. 2.

Furthermore, for its part, the control means 9 may have at least one electric circuit support such as a printed circuit board, PCB, 27 and electronic and/or electrical components 29 carried by the support 27. These electronic and/or electrical components may for example comprise a microcontroller and electrical contacts connected to the resistive tracks of the enclosure 13. The electrical contacts are for example carried by a face of the PCB support 27 that is opposite the face that carries for example the microcontroller.

The support 27 may also carry at least one power and signal connector 31.

The heating device 5 may also have a protective cover 33 for the control means 9. This cover 33 has an opening for the connector 31 to pass through.

The control means 9 is arranged at a longitudinal end of the cylindrical enclosure 13 carrying the heating means.

In this case, the control means 9 is positioned in the region of the end of the housing of the heating device 5 accommodating the heating module 7. The device 5 thus has a support 35 for the control means 9 positioned so as to close this housing accommodating the heating module 7.

The support 35 for the control means 9 may be positioned in a manner bearing against the core 11 of the heating module 7, as the example in FIG. 2 illustrates.

In addition, the protective cover 33 for the control means 9 is fixed to this support 35 for the control means 9.

A sealing means 37 between the protective cover 33 for the control means 9 and the support 35 for the control means 9 may also be provided. This is for example an O-ring 37.

A heating device 5 that is thus produced makes it possible to limit the head loss while having a reduced space requirement compared with some solutions from the prior art.

A second embodiment of the heating device 105, shown schematically in FIG. 3, differs from the first embodiment in that the heating module 107 no longer has a central core surrounded by the cylindrical enclosure 113.

By contrast, in this second embodiment, the enclosure 113 has at least one opening 139 in which a heating means 114 is positioned.

The inlet canal 123 and outlet canal 125 lead into the heating device 105 around the enclosure 113. Thus, the enclosure 113 defines a circuit for guiding the liquid around the enclosure 113 accommodating the heating means 114.

In this case, the reserve of heated liquid is around the enclosure 113.

Moreover, in this second embodiment, the heating means 114 may have heating elements having a positive temperature coefficient. These are known as PTC heating elements.

These PTC heating elements are protected from overheating or an overcurrent.

The number of PTC heating elements is chosen depending on the power required in accordance with the application. A PTC heating element may for example be configured for power of around 500 W to 1 kW.

Each heating means 114 has two terminals 141 for connecting the PTC heating elements to electric potentials via the control means 109.

Thus, heating takes place by immersion of the PTC heating elements.

Moreover, the support 135 for the control means 109 is produced for example in one piece with the cylindrical enclosure 113.

According to this second embodiment, the enclosure 113 of the heating module 107 thus carries out, at the same time:

a function of accommodating the heating means 114,

a function of closing the housing of the device 105 accommodating the heating module 107, and also

a function of supporting the control means 109 of the heating module 107.

A heating device 105 produced in this way makes it possible to further decrease the head loss, and the transfer of heat energy is increased.

Finally, a third embodiment of the heating device 205 is illustrated in a simplified manner in FIG. 4.

This third embodiment differs from the first embodiment in that the heating module 207 also does not have a central core surrounded by the cylindrical enclosure 213 so as to define the guiding circuit between the core and the enclosure.

By contrast, in this third embodiment, the cylindrical enclosure 213 bears for example against the internal walls of the body of the device 205, and the inlet canal 223 and outlet canal 225 lead into the interior of the cylindrical enclosure 213.

The guiding circuit 215 is thus defined in the interior of the cylindrical enclosure 213.

The device 205 also has a partition 243 which extends in the interior of the cylindrical enclosure 213.

By extending in the interior of the enclosure 213, the partition 243 creates turbulence in the flow of the liquid to be heated. This turbulence makes it possible to improve heat exchange.

In addition, this partition 243 may be produced in one piece with the support 235 for the control means 209.

In this case, the support 235 thus carries out, at the same time:
a function of supporting the control means of the heating module 207,
a function of closing the housing of the device 205 accommodating the heating module 207, and also
a function of disrupting the flow of liquid in the guiding circuit 215.

A heating device 205 produced in accordance with this third embodiment makes it possible to further decrease the head loss compared with the first and second embodiments.

Moreover, the reserve of heated liquid in the interior of the cylindrical enclosure 213 has a greater capacity than the second embodiment.

Finally, the transfer of heat energy is also improved compared with the second embodiment.

It will thus be understood that a heating device 5, 105, 205 produced in accordance with any one of the embodiments described above with one or more heating modules 7, 107, 207 as described, making it possible to define a guiding circuit in the interior of the heating module 7, 107, 207, makes it possible to limit the head loss while having a reduced space requirement.

1. An electrical liquid heating device for a motor vehicle, the device comprising at least one module for heating the liquid, with the at least one heating module comprises:
an approximately cylindrical enclosure (13, 113, 213) having at least one means (114) for heating the liquid and delimiting a circuit (15, 115, 215) for guiding the liquid to be heated, and
a control means (9, 109, 209) of the at least one heating means (114), positioned facing one end of the cylindrical enclosure (13, 113, 213).

2. The device as claimed in claim 1, further comprising at least one liquid inlet canal (23, 123, 223) and at least one liquid outlet canal (25, 125, 225) communicating with the circuit (15, 115, 215) for guiding the liquid, the canals being provided in the device in a manner approximately perpendicular to a longitudinal axis (A) of the cylindrical enclosure (13, 113, 213).

3. The device as claimed in claim 1, wherein the cylindrical enclosure (13, 213) has at least one resistive track connected to the control means (9, 209).

4. The device as claimed in claim 1, wherein the at least one heating module (7) comprises a core (11) positioned in an interior of the cylindrical enclosure (13) so as to define a circuit (15) for guiding the liquid between the core (11) and the cylindrical enclosure (13).

5. The device as claimed in claim 4, wherein the core (11) has an approximately cylindrical overall shape.

6. The device as claimed in claim 4, wherein the core (11) has at least one external groove (17) facing the cylindrical enclosure, for example having an approximately helical or circular shape.

7. The device as claimed in claim 4, wherein the core (11) has an interior hollow communicating with the guiding circuit (15) so as to act as a reserve for the heated liquid and as an expansion vessel.

8. The device as claimed in claim 2, wherein the cylindrical enclosure (113) has at least one opening (139) in which the at least one heating means (114) is positioned.

9. The device as claimed in claim 8, wherein the inlet canal (123) and outlet canal (125) lead into a circuit (115) for guiding the liquid, the circuit being defined around the cylindrical enclosure (113).

10. The device as claimed in claim 8, wherein the at least one heating means (114) has heating elements having a positive temperature coefficient.

11. The device as claimed in claim 8, wherein the cylindrical enclosure (113) has a support (135) for the control means (109), produced in one piece with the cylindrical enclosure (113).

12. The device as claimed in claim 1, further comprising a partition (243) extending in the interior of the cylindrical enclosure (213).

13. The device as claimed in claim 12, wherein the inlet canal (223) and outlet canal (225) lead into the interior of the cylindrical enclosure (213).

14. The device as claimed in claim 12, wherein the partition (243) is produced in one piece with a support (235) for said control means (209).

15. The device as claimed in claim 2, wherein the inlet canal (23, 123, 223) and outlet canal (25, 125, 225) extend approximately radially with respect to the cylindrical enclosure (13, 113, 213).

16. The device as claimed in claim 2, wherein the inlet canal (23, 123, 223) and outlet canal (25, 125, 225) are positioned so as to form a projection with respect to the heating module (7, 107, 207).

17. The device as claimed in claim 2, wherein the inlet canal (23, 123, 223) and outlet canal (25, 125, 225) are positioned in an opposing manner on two opposite sides of the heating module (7, 107, 207).

18. The device as claimed in claim 2, further comprising a protective cover (33, 133, 233) for the control means (9, 109, 209).

19. The device as claimed in claim 18, further comprising sealing means (37, 137, 237) between the protective cover (33, 133, 233) and the support (35, 135, 235) for the control means (9, 109, 209).

20. A heating and/or air-conditioning unit for a motor vehicle comprising at least one heating device (5, 105, 205) as claimed in claim 1.
